(19) United States
(12) Patent Application Publication
(10) Pub. No.: US 2021/0162293 A1
(43) Pub. Date: Jun. 3, 2021

(54) EXERCISE GAME KIT AND METHOD

(71) Applicants: Donald Cropek, Champaign, IL (US); Cameron Cropek, San Francisco, CA (US)

(72) Inventors: Donald Cropek, Champaign, IL (US); Cameron Cropek, San Francisco, CA (US)

(21) Appl. No.: 16/700,456

(22) Filed: Dec. 2, 2019

(51) Int. Cl. A63F 1/04; A63F 13/816; A63B 21/072

(52) U.S. Cl. CPC A63F 1/04; A63F 13/816; A63F 2001/0441; A63F 2001/0475; A63B 21/072

(57) ABSTRACT

A exercise game kit and method is described herein that directs a group of participants to perform a variety of exercises based on whether a participant finds matching cards of an array of cards. With each turn, a participant can receive or avoid an exercise, while other participants may also receive an exercise.

### FIELD OF THE DISCLOSURE

The present disclosure generally relates to exercise activities and, more particularly, to card-based exercise activities.

### BACKGROUND

A common issue with working out is maintaining motivation both to go to the gym and to continue a workout. To help with this, many people turn to personal trainers or classes to receive directed workouts. Moreover, introducing variation into a workout can help avoid boredom and increase the challenge presented. Accordingly, ways to increase the variation and fun individuals experience when working out are helpful to maintain a consistent workout regimen.

### SUMMARY

In accordance with a first aspect, a method for directing exercise activities for a plurality of participants is described that includes arranging a deck of cards face down in an array, where the face of each of the cards has exercise indicia thereon including an exercise and a number of repetitions. The deck of cards includes cards having a predetermined number of different exercises and is composed of pairs of cards having matching indicia. The method further includes directing a first participant to flip over first and second cards in the array. When the first and second cards have matching indicia, the method includes directing the participants other than the first participant to perform the exercise in the identified number of repetitions shown on the face of the two cards and removing the first and second cards from the array. When the first and second cards have mismatched indicia, the method includes directing the first participant to cast a token having a first side and a second side, directing the first participant to perform the exercise in the identified number of repetitions of the first card in response to the cast token showing the first side and directing the first participant to perform the exercise in the identified number of repetitions of the second card in response to the cast token showing the second side, and replacing the first and second cards face down in the array.

In some forms, the method can include, when the first and second cards have mismatched indicia, directing the participants other than the first participant to perform the exercise in the identified number of repetitions of the first card in response to the cast token showing the second side and directing the participants other than the first participant to perform the exercise in the identified number of repetitions of the second card in response to the cast token showing the first side.

In some forms, the method can include directing each of the participants to be the first participant in turn until all of the cards are removed from the array. In further forms, the method can include determining a winner corresponding to a participant having matched the most cards and/or, when all of the cards are removed from the array, directing each of the participants to perform a final exercise in a number of repetitions determined by subtracting a number of removed cards from the array for each participant from a predetermined number. Optionally, the final exercise can be determined by selecting a final exercise card from a second deck of cards, where each card in the second deck of cards has a face with final exercise indicia thereon including an exercise and a beginning number of repetitions.

In accordance with a second aspect, a non-transitory computer readable medium having instructions stored thereon is described, where the instructions are configured to cause a computing device to perform operations corresponding to one or more of the above methods.

In accordance with a second aspect, a game kit for directing exercise activities is described that includes a deck of cards, where each of the cards has a face with exercise indicia thereon including an exercise and an exercise number, and a two sided token. The deck of cards includes cards having a predetermined number of different exercises and being composed of pairs of cards having matching indicia.

According to some forms, the exercise indicia can include an exercise group type. In further forms, the exercise group type can include a particular body part and/or a workout goal.

According to some forms, the exercise number can include a number of repetitions. In further forms, the exercise number can include a number of sets and/or a weight.

According to some forms, the exercise number can include a plurality of different numbers providing a plurality of levels of difficulty and/or the kit can include a final exercise deck of cards, where each of the cards in the final exercise deck has a face with indicia thereon including an exercise and a number of repetitions. The exercises of the cards in the final exercise deck are different than the exercises of the cards in the deck.

### BRIEF DESCRIPTION OF THE DRAWINGS

The above needs are at least partially met through provision of the embodiments described in the following detailed description, particularly when studied in conjunction with the drawings, wherein:

FIG. 1 is a perspective view of an example exercise game kit including a deck of cards, a final exercise deck of cards, and a token in accordance with various embodiments;

FIG. 2 is a top plan view of a back face of an example card of the deck of cards of FIG. 1;

FIG. 3 is a top plan view of a front face of a first example card of the deck of cards of FIG. 1;

FIG. 4 is a top plan view of a front face of a second example card of the deck of cards of FIG. 1;

FIG. 5 is a top plan view of a front face of a first example card of the final exercise deck of cards of FIG. 1;

FIG. 6 is a diagrammatic view of a game setup using the exercise game kit of FIG. 1 in accordance with various embodiments; and

FIG. 7 is a flowchart of an exercise game in accordance with various embodiments;

FIG. 8 is a diagrammatic view of an example computing device in accordance with various embodiments.

### DETAILED DESCRIPTION

A exercise game kit and method is described herein that directs a group of participants to perform a variety of exercises based on how the game plays out. With each turn, a participant can receive or avoid an exercise, while other participants may also receive an exercise. The game kit includes a deck of cards with matched pairs having the same exercise and number of repetitions. With this configuration, participants are tasked with finding the matched pairs, either by luck or memory. The resulting game session advantageously provides a comprehensive workout, which can be tailored as desired, while also providing fun and challenging group gameplay.

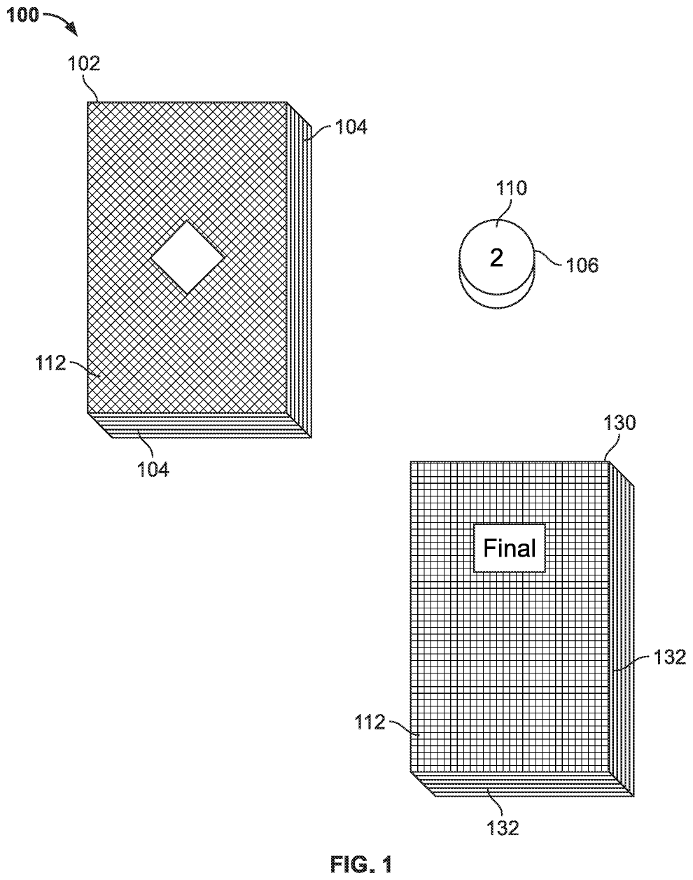

Details of an example game kit 100 are shown in FIGS. 1-6. The kit 100 includes a deck 102 of cards 104 and a token 106. The token 106 can be any object with first and second sides 108, 110, so that the token 106 can be utilized to select between first and second options. For example, the token 106 can be coin, so that a user can flip the coin when needed and the first face 108 can display a “1” or other first option and the second face 110 can display a “2” or other second option. Alternatively, the token 106 can be a die having two face options or other suitable members.

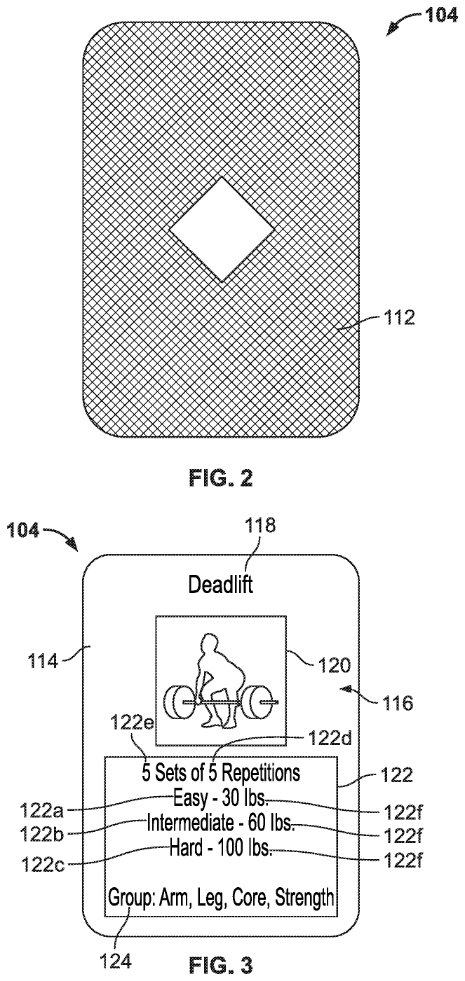

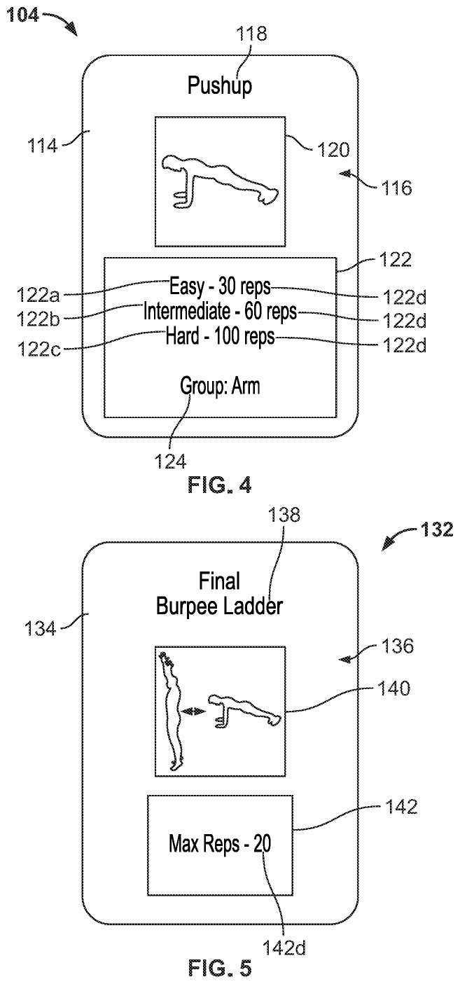

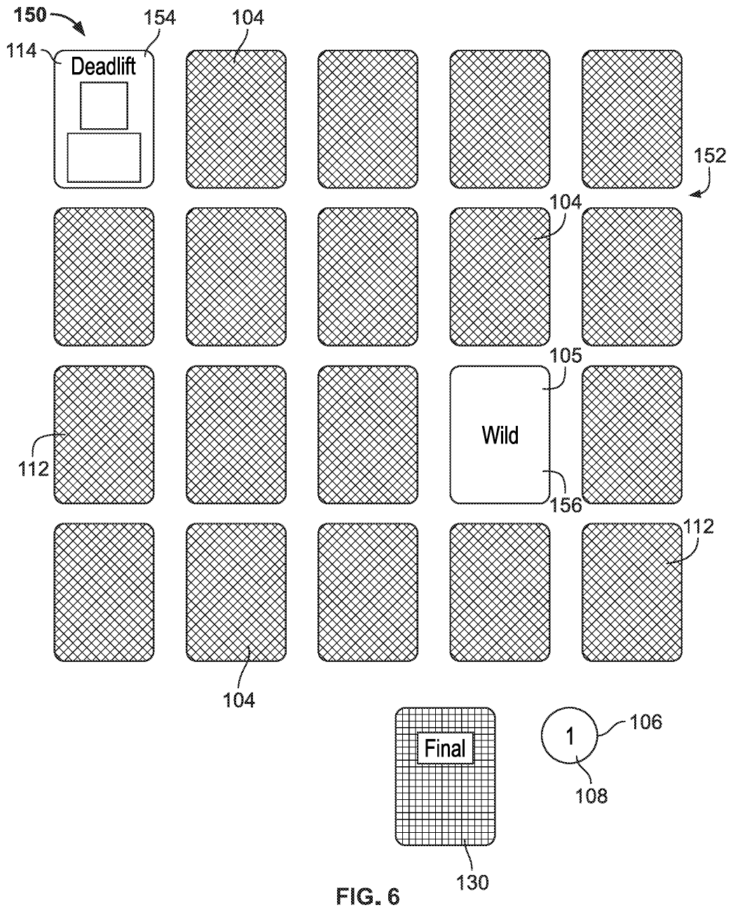

Each card 104 in the deck 102 is directed to a particular exercise with an associated predetermined exercise value. Example cards 104 are shown in FIGS. 2 to 4. An example back 112 for the cards 104 is shown in FIG. 2 that includes a graphic, pattern, and/or alphanumeric content, including a company logo, for example. A front face 114 of each the cards 104, as shown in FIGS. 3 and 4, can have indicia 116 printed or otherwise disposed thereon that includes an exercise title 118, an illustration or graphic 120 representing the exercise, and an exercise number 122. The illustration or graphic 120 can be an illustration showing a person or cartoon performing the exercise, a photo of a model performing the exercise, or the like. In some versions, one or more of the cards 104 can be a wild card 105 (FIG. 6) that can be used, as described below, to match any of the other cards 104 in the deck.

If desired, the exercise number 122 can include tiered values, such as an easy value 122a, an intermediate value 122b, and a hard value 122c corresponding to different difficulty or experience levels. Of course, rather than 3 tiered values, it will be understood that two tiered values or more than three tiered values can be utilized, as desired. The tiered values allow people having a wide variety of experience and stamina to participate in the game together by selecting the appropriate difficulty for each person. Further, while a repetition number 122d for the exercise number 122 is suitable for many exercises, the exercise number 122 can also include a number of sets 122e in addition to a number of repetitions 122d that a participant has to perform and/or a weight value 122f for a participant to perform the exercise with, e.g., a kettlebell weight, a medicine ball weight, a barbell weight, loaded bar weight, etc. In these forms, the difficulty levels can include tiered sets and/or repetitions, as well as tiered weight values. In alternative versions, the kit 100 can include one or more decks 102 having specific difficulty levels. In one example, the kit 100 can be provided with a single deck having an associated difficulty, such as easy, intermediate, or hard, and participants can select a plurality of kits 100 to obtain multiple levels of difficulty. In another example, the kit 100 can be provided with two, three, or more decks having different difficulties with respect to one another.

In some versions, the indicia 116 can further include an exercise group type 124, which allows participants to tailor a game to work on particular workout aspects, such as exercises directed to particular body parts, e.g., arms, legs, core, back, etc., or exercises directed to workout goals, e.g., strength, conditioning, endurance, speed, etc. Decks 102 can be provided where all of the cards 104 are directed to a particular body part workout or workout goal, combinations thereof, or mixed. In other versions, the deck 102 can be directed to a particular exercise and the cards can have varying numbers of repetitions 122d, sets 122e, and/or weights 122f corresponding to the particular exercise.

In the illustrated example of FIG. 3, the indicia 116 is directed to a deadlift, which is shown in the exercise title 118. The illustration 120 shows a person in a squatting position prior to lifting the weight. Further, the exercise number 122 includes an easy value 122a that includes three sets 122e of five repetitions 122d at 30 pounds 122f, an intermediate value 122b that includes three sets 122e of five repetitions 122d at 60 pounds 122f, and a hard value 122c that includes three sets 122e of five repetitions 122d at 100 pounds 122f. Other versions could vary the number of sets 122e and/or repetitions 122d in addition to or in alternative to the weight 122f. The indicia 116 further includes an exercise group type 124 of arm, leg, core, strength exercises.

In the illustrated example of FIG. 4, the indicia 116 is directed to a push-up, which is shown in the exercise title 118. The illustration 120 shows a person in a raised position performing a push-up. Further, the exercise number 122 includes an easy value 122a of 15 push-ups 122d, an intermediate value 122b of 30 push-ups 122d, and a hard value 122c of 45 push-ups 122d. The indicia 116 further includes an exercise group type 124 of arm exercises.

In one form, the game kit 100 can further include a final exercise deck 130 of cards 132. Each card 132 in the final exercise deck 130 is directed to a particular “hard” exercise with an associated predetermined exercise number. An example card 132 is shown in FIG. 5. A front face 134 of the card 132 can have indicia 136 printed or otherwise disposed thereon that includes an exercise title 138, an illustration or graphic 140 representing the exercise, and an exercise number 142. The illustration or graphic 140 can be an animation showing a person or cartoon performing the exercise, a photo of a model performing the exercise, or the like. The exercise number 142 can have a similar form to the above-described exercise number 122. In any case, the exercise number 142 includes a repetition number 142d that provides a benchmark from which participants can reduce, as described in more detail below. In an alternative version, the participants can utilize the regular deck 102 to select a final exercise, such as by the selection of one of the cards 104 from the deck 102 after shuffling.

It will be readily understood how the card formats described herein can be utilized for any type of desired exercise. For example, the exercises can include one or more of the following: air squat, front squat, overhead squat, shoulder press, push press, push jerk, deadlift, medicine ball clean, sumo deadlift high pull, thruster, wall ball, pull up, burpee, jump rope, push up, overhead press, row, handstand push, sit up, plank, back hyperextension, rope climb, bench press, clean jerk, running, snatch, back squat, squat jerk, split jerk, barbell row, ring muscle up, bar muscle up, ring handstand push up, handstand walk, double unders, box jumps, or kettlebell swing. It will be understood, however, that the above list is merely for illustration and that any other exercises are within the scope of this disclosure.

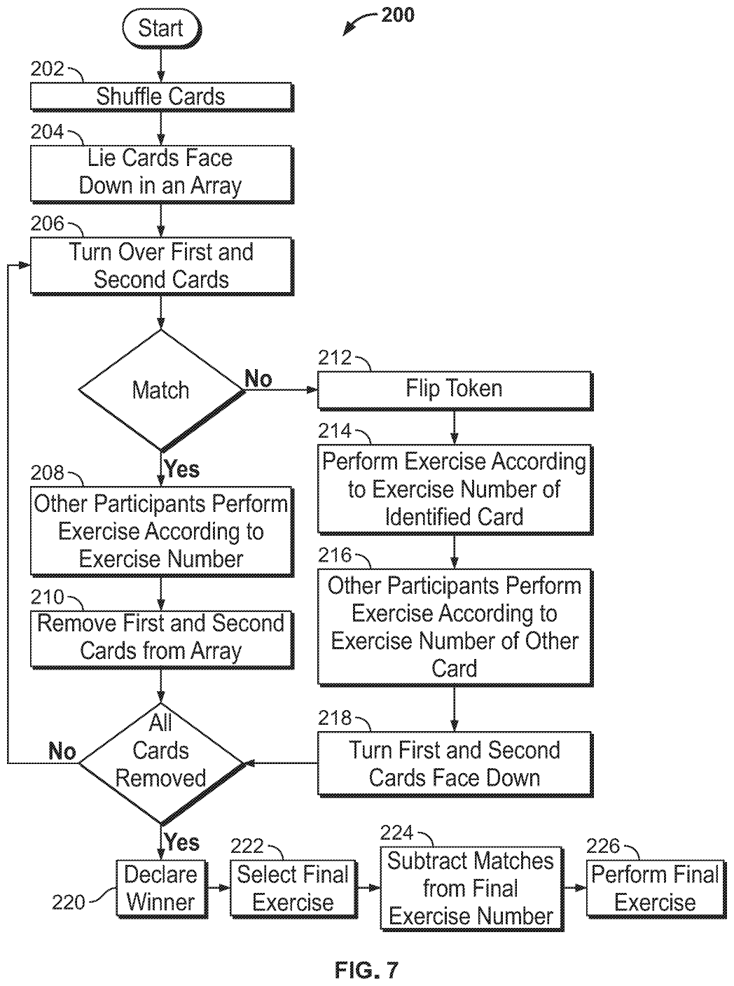

An exercise game 150 for a plurality of participants utilizing the above-described exercise deck 102 and, optionally, the final exercise deck 130, is shown in FIG. 6 and a method 200 of playing the game 150 is shown in FIG. 7. In first and second steps 202, 204, the cards 104 are shuffled and then laid front face 114 down in an array 152. After the participants determine an order of play, in a third step 206, the first participant turns over a first card 154 and a second card 156, which can be any cards 104 in the array 152.

If the indicia 116 of the first and second cards 154, 156 match, in a fourth step 208, the first participant performs no exercise and the participants other than the first participant performs the identified exercise 118 according to the shown exercise number 122. In a fifth step 210, the first participant then removes the matched first and second cards 154, 156 from the array 152 leaving the associated gaps in the array 152, i.e., no other cards 104 are moved or arranged. If the indicia 116 of the first and second cards 154, 156 do not match, in a sixth step 212, the first participant flips or tosses the token 106 and, in a seventh step 214, performs the identified exercise 118 according to the shown exercise number 122 of the first card 154 if the first side 108 of the token 106 is shown and performs the identified exercise 118 according to the shown exercise number 122 of the second card 156 if the second side 110 of the token 106 is shown. If desired, in an optional eighth step 216, the participants other than the first participant perform the identified exercise 118 according to the shown exercise number 122 of the first or second cards 154, 156 not performed by the first participant. Thereafter, in a ninth step 218, the first and second cards 154, 156 are flipped face down in the same spots in the array 152. Play then passes to a second participant who performs the same steps. Play continues until all of the cards 104 are removed from the array 152 as a result of being matched by one of the participants. In a tenth step 220, a winner of the game 150 is declared as the participant with the most matches. In an alternative version, the first participant's turn can keep going in response to matching the first and second cards 154, 156, allowing the first participant to two over at least two additional cards 104.

In another version, one or more wild cards 105 can be included in the deck 102 and disposed within the array 152. In one form, if a participant flips over the wild card 105, the participant can select one of the cards 104 in the deck 104 to make the other participants to perform the exercise shown. This will allow the participant to select a difficult exercise for the other participants or an exercise that the other participants particularly dislike. In this instance, the wild card 105, as well as, the selected card 104 are removed from the array 152. When the matching card 104 for the selected card 104 is uncovered, the matching card 104 can simply be removed from the array and the active participant can select another card 104. In another form, if a participant flips over the wild card 105, either as the first or second card 154, 156, the wild card 105 will automatically match the other of the first or second cards 154, 156 and the participant performs no exercise, while the other participants perform the identified exercise 118 according to the shown exercise number 122 of the other of the first or second cards 154, 156. In this instance, the wild card 105 is removed from the array 152 and the other of the first or second cards 154, 156 can either be replaced in the array or removed. If the card is removed, when the matching card 104 for the removed card 104 is uncovered, the matching card 104 can simply be removed from the array and the active participant can select another card 104.

The value and risk of the game 150 can be increased by a final, difficult exercise that is performed after all the cards 104 are matched and a winner is declared. With this form, in an eleventh step 222, the participants select the final exercise. As discussed above, the final exercise has a predetermined number of repetitions. The game method 200 utilizes this value in a twelfth step 224, allowing each participant to subtract the number of matches or number of matched cards 104 they acquired during the game 150 from the predetermined number of repetitions of the final exercise. Accordingly, playing well in the game allows a participant to reduce the burden imposed by the final exercise. Finally, in a thirteenth step 226, all participants perform the final exercise according to their own number of repetitions.

In one example, the final exercise can be a burpee ladder with 20 repetitions. Each participant decreases the benchmark repetition number of 20 by subtracting the number of matches they acquired during the game 150, e.g., a player with 4 matches begins the burpee ladder at 16.

Rather than selecting the final exercise as a group or choosing one participant to select the final exercise, the final exercise can be determined by selection of one of the cards 132 from the final exercise deck 130. The winner, or one of the other participants at random, can select the final exercise card 132, for example, at the beginning or end of the game 150. The exercises on the final exercise cards 132 can be more difficult and different than the exercises in the above-described deck 102.

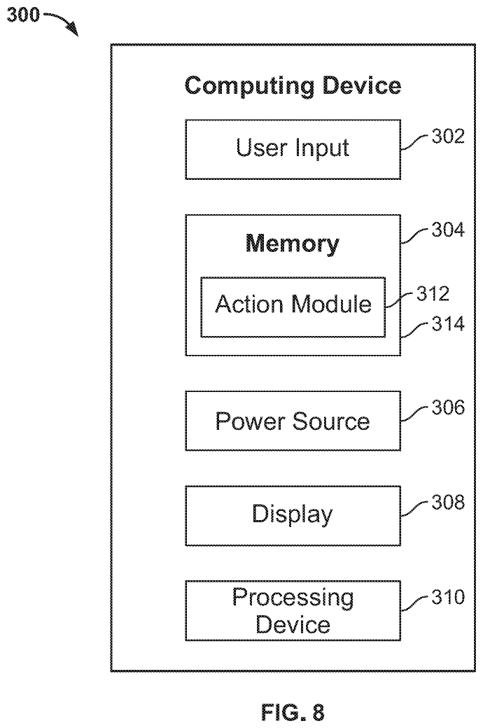

In another version, the exercise game 150 can be provided in electronic format so that participants can operate the game 150 using a suitable computing device. In these forms, the method shown in FIG. 7 can be implemented by participants interacting with a software algorithm operating on a computing device 300 as shown in FIG. 8, such as a mobile phone, tablet, E-reader, and so forth. The computing device 300 can include one or more graphical user interfaces (GUIs) providing display actions provided by application software operating on the computing device 300 to allow participants to perform the actions set forth in the method shown in FIG. 7. The computing device 300 can be configured as commonly understood to include a user input 302, such as a touch screen, keypad, switch device, voice command software, or the like, a memory 304, a power source 306, which can be replaceable or rechargeable as desired, a display 308, and a processing device 310 controlling the operation thereof.

The term processing devices, as utilized herein, refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processing devices disclosed herein may be configured (for example, by using corresponding programming stored in a memory as will be well understood by those skilled in the art) to carry out one or more of the steps, actions, and/or functions described herein.

Referring back to FIG. 1, the client device 300 can include an action module 312 stored in the memory 304 as a set of instructions executable by the processing device 310. The action module 312 is configured to receive inputs from the user input 302 of the device 300 to identify game selection events and control the application of the selection events. If desired, the functionality of the action module 312 can be implemented as an action module application programming interface (API) 314 stored in the memory 304 that can include any content that may be suitable for the techniques of the current disclosure, which various applications executing on servers and/or client devices can invoke. For example, the API 314 may perform a corresponding action to the array of cards 152 upon selection of individual ones of the cards 104 by a participant in response to a detected event of the computing device 300 detected by the action module 312. The action module 312 can invoke the API 314 when necessary, without external communications. In other versions, one or more steps of the methods/algorithms can have cloud-based processing and/or storage with a remote processing system including an action module, configured as described with the above form, stored in a memory as a set of instructions executable by a processing device.

The application software described herein can be available for purchase and/or download from any website, online store, or vendor over any suitable communication network, such as the internet, radio, Bluetooth, etc. Alternatively, a user can download the application onto a personal computer and transfer the application to the computing device 300. When operation is desired, the user runs the application on the computing device 300 by a suitable selection through the user input 302.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Any desired number of cards 104 can be provided in the deck 102. For example, the deck 102 can have thirty cards 104 representing fifteen matched pairs (or fewer if wild cards 105 are used). Of course, other numbers of cards 104 could be used, such as between ten cards up to fifty cards or more.

So configured, the game kit 100 and game 150 provides fun motivation and group exercise through the use of memorization to remember where matches are as cards 104 are flipped or luck to happen upon matches.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A method for directing exercise activities for a plurality of participants, the method comprising:
arranging a deck of cards face down in an array, the face of each of the cards having exercise indicia thereon including an exercise and a number of repetitions, the deck of cards including cards having a predetermined number of different exercises and being composed of pairs of cards having matching indicia;
directing a first participant to flip over first and second cards in the array;
when the first and second cards have matching indicia:
directing the participants other than the first participant to perform the exercise in the identified number of repetitions shown on the face of the two cards; and
removing the first and second cards from the array;
when the first and second cards have mismatched indicia:
directing the first participant to cast a token having a first side and a second side;
directing the first participant to perform the exercise in the identified number of repetitions of the first card in response to the cast token showing the first side and directing the first participant to perform the exercise in the identified number of repetitions of the second card in response to the cast token showing the second side; and
replacing the first and second cards face down in the array.

2. The method of claim 1, further comprising, when the first and second cards have mismatched indicia, directing the participants other than the first participant to perform the exercise in the identified number of repetitions of the first card in response to the cast token showing the second side and directing the participants other than the first participant to perform the exercise in the identified number of repetitions of the second card in response to the cast token showing the first side.

3. The method of claim 1, further comprising directing each of the participants to be the first participant in turn until all of the cards are removed from the array.

4. The method of claim 3, further comprising determining a winner corresponding to a participant having matched the most cards.

5. The method of claim 3, further comprising, when all of the cards are removed from the array, directing each of the participants to perform a final exercise in a number of repetitions determined by subtracting a number of removed cards from the array for each participant from a predetermined number.

6. The method of claim 5, further comprising selecting a final exercise card from a second deck of cards, each card in the second deck of cards having a face with final exercise indicia thereon including an exercise and a beginning number of repetitions.

7. A kit for directing exercise activities, the kit comprising:
a deck of cards, each of the cards having a face with exercise indicia thereon including an exercise and an exercise number, the deck of cards including cards having a predetermined number of different exercises and being composed of pairs of cards having identical exercise indicia allowing a user to selectively match each pair of cards by turning over two of the cards; and
a token.

8. The kit of claim 7, wherein the exercise indicia further includes an exercise group type.

9. The kit of claim 8, wherein the exercise group type comprises at least one of: a particular body part or a workout goal.

10. (canceled)

11. The kit of claim 7, wherein the exercise number comprises a number of repetitions.

12. The kit of claim 11, wherein the exercise number further comprises a number of sets.

13. The kit of claim 11, wherein the exercise number further comprises a weight.

14. The kit of claim 7, wherein the exercise number comprises a plurality of different numbers providing a plurality of levels of difficulty.

15. The kit of claim 7, further comprising a final exercise deck of cards, each of the cards in the final exercise deck having a face with indicia thereon including an exercise and a number of repetitions, the exercises of the cards in the final exercise deck being different than the exercises of the cards in the deck.

16. A non-transitory computer readable memory having instructions stored thereon, the instructions configured to cause a computing device to perform operations, the operations comprising:
arranging a deck of cards face down in an array, the face of each of the cards having exercise indicia thereon including an exercise and a number of repetitions, the deck of cards including cards having a predetermined number of different exercises and being composed of pairs of cards having matching indicia;
directing a first participant to flip over first and second cards in the array using a user input of the computing device;
when the first and second cards have matching indicia:
directing the participants other than the first participant to perform the exercise in the identified number of repetitions shown on the face of the two cards; and
removing the first and second cards from the array;
when the first and second cards have mismatched indicia:
directing the first participant to cast a token having a first side and a second side;
directing the first participant to perform the exercise in the identified number of repetitions of the first card in response to the cast token showing the first side and directing the first participant to perform the exercise in the identified number of repetitions of the second card in response to the cast token showing the second side; and
replacing the first and second cards face down in the array.

17. The non-transitory computer readable medium of claim 16, the operations further comprising, when the first and second cards have mismatched indicia, directing the participants other than the first participant to perform the exercise in the identified number of repetitions of the first card in response to the cast token showing the second side and directing the participants other than the first participant to perform the exercise in the identified number of repetitions of the second card in response to the cast token showing the first side.

18. The non-transitory computer readable medium of claim 16, the operations further comprising directing each of the participants to be the first participant in turn until all of the cards are removed from the array.

19. The non-transitory computer readable medium of claim 18, the operations further comprising determining a winner corresponding to a participant having matched the most cards.

20. The non-transitory computer readable medium of claim 18, the operations further comprising, when all of the cards are removed from the array, directing each of the participants to perform a final exercise in a number of repetitions determined by subtracting a number of removed cards from the array for each participant from a predetermined number.

21. The kit of claim 7, wherein the token comprises a first side having a first indicator thereon and a second side having a second indicator thereon, where the first indicator is different from the second indicator, the token configured to be selectively tossed by a user in response to two cards being turned over that do not have identical exercise indicia thereon to identify which of the two cards directs an exercise of the user and which of the two cards directs an exercise of other participants.
